(19) United States
(12) Patent Application Publication
(10) Pub. No.: US 2019/0051008 A1
(43) Pub. Date: Feb. 14, 2019

(54) Method for measuring the circumference/width/length of a human body or object using a picture/photograph from a mobile camera or web camera feature.

(71) Applicant: Deborah Jane Barker, Pittsburgh, PA (US)

(72) Inventor: Deborah Jane Barker, Pittsburgh, PA (US)

(21) Appl. No.: 15/676,893

(22) Filed: Aug. 14, 2017

(51) Int. Cl. G06T 7/62; G06F 3/0484

(52) U.S. Cl. CPC G06T 7/62; G06F 3/04842; G06T 2200/24; G06T 2207/30196; G06T 2207/10004

(57) ABSTRACT

This is a method of showing a visual measurement/circumference/width/length of parts/areas of a human body or object.

A user takes a picture of his or her current body or object and then selects the area on the picture of the current body or object that they wish to measure. The user then views the circumference/width/length of the area/parts of a human body or object using a picture. Photograph of a human body object from a mobile camera or web camera feature.

This Application claims the benefit under 37 CFR 1.55 o 1.78 for AIA of the earlier filing date of U.S. Provisional Patent Application Ser. No. 62/494,792 filed on Aug. 16, 2016 which is incorporated by reference in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION BY REFERENCE OF MATERIALS SUBMITTED ON A COMPACT DISC

Not Applicable

### BACKGROUND OF THE INVENTION

The invention allows a user to view the circumference of parts/areas of a human body or object using a picture/photograph from a mobile camera or web camera feature.

The user enters their height in feet and inches. A picture/photograph is taken of the user's current body front view and then side view by following a visual outline and audio instructions on how to stand which are provided using a mobile or web camera feature. Indicators are provided on the mobile or web screen which prompt and allow user to provide a line at the top of the head and the bottom of their feet. The user then follows the audio instructions and taps the camera icon that appears on the screen to take a picture/photograph of themselves. The user may also choose to have someone else to take the picture/photograph.

The user then views a front picture/photograph of their current body or object and indicates by tapping the specific area on the picture of the current body or object to indicate the desired circumference measurement. The user then views a side picture/photograph of their current body or object and moves the indicators to the same specific area on the side view of the picture of the body or object.

The circumference of the human body or object is then displayed on the screen of the mobile or web device.

The user can then store the circumference measurement in the menu screen section provided on the mobile or web device.

The user may then return to the original front view picture/photograph by selecting the “back” tab on the picture screen of the human body or object and measure the circumference of additional areas/parts of the human body or object following the previous procedure.

The Problem the Inventor Addressed

According to statistics more than 75% of people in the United States do not know the circumference of their waist.

There does not exist a virtual measuring system that allows a user to view, measure and store the circumference of their current human body using a using a picture/photograph from a mobile or web camera feature.

There exist technology to measure objects using a mobile or web camera feature but not one that allows a user to instantly view the circumference of a plurality of body parts/areas of their human body parts using a picture/photograph of the human body.

Most measuring devices are not accurate due to user error. The invention eliminates error through audio and visual checks not allowing the user to continue if the information is not correct, this eliminates opportunity for error. Because the user can obtain their specific circumference measurement within seconds of taking the picture/photograph of their current human body this invention reduces errors in ordering items of clothing on line and also in retail stores.

It is estimated that on line returns collectively cost retailers billions of dollars, the cost this problem is directed to the cost of goods to consumers. The savings created by proper sizing can ultimately be passed on to consumers

The invention also addresses the problem with individuals that wish to lose weight or change the composition of their body. One of the biggest problems in weight loss is, Retention, when individuals do not see results quickly enough on a weight loss program they get discouraged and ultimately quit their weight loss or fitness program. The invention can help personal trainers, fitness professionals, gyms owners, coaches, physical therapist, insurance companies and health care providers help their clients/patients/consumers set realistic goals and view results of how they are benefiting from their specific wellness programs.

The invention solves this problem by showing the user how their current human body circumference is changing as it relates to exercise and diet weight loss or weight gain. The invention will keep users motivated towards reaching their wellness goals because the user will see composition change even when they do not see significant weight loss.

The invention solves a global problem of alerting users to risk factors that are associated with a high waist to height ratio (WHtR). Knowing the circumference of the waist area can offer user's coaches/trainers/health care providers/insurance company's solutions to decreasing WHtR and decrease health care cost related to diseases such as Type 2 diabetes and Heart Disease through awareness and targeting information on how to prevent these diseases.

The invention will show users if their WHtR is high by allowing the user to view their picture/photograph on the mobile or web screen the users current WHtR and what the healthy circumference should be. This information can help the user focus on a specific problem and health risk area.

The invention will alert health care providers/wellness coaches/physical therapist/insurers to a specific area of concern for their patients. The user can provide critical body change information to their health care provider/insurance company/personal coach/wellness coach. The users can be motivated and directed to continue towards wellness goals through communication transferred through the mobile or web device.

The invention can be used by users, coaches and health care providers to keep track of swelling in any area of the human body parts/areas by taking a picture/photograph of the parts/area where swelling has occurred and report this information.

The invention can be used for post-operative care to ensure that fluid or swelling is not occurring the particular area of surgery. The invention can be very helpful with heart patients' specifically as fluid buildup or swelling in feet hands or abdominal area can be extremely dangerous.

The invention will collect and store valuable human body and the change in the circumference human body data. This information can be helpful to determine health risk by insurance companies/health care providers globally.

The Invention will collect and store valuable human body data and the change in the circumference of the human body parts which will be valuable to retailers and clothing manufacturers. The invention will give retailers and manufacturers a better understanding of the size and shape of their consumers which will allow for better product sizing.

### BRIEF SUMMARY OF THE INVENTION

The method to measure width/length/circumference of parts/areas of a human body or object by using a picture/photograph from a mobile camera or web camera feature.

This is a method of enabling a user to see visual circumference and/or change in circumference of their human body and parts/areas of their human body by using a picture/photograph from a mobile or web camera feature.

The user enters their current height or the height of the object in inches. The user is then prompted through audio and visual instructions using the audio and visual features on the mobile or web device of how and where to stand to stand within the frame on the screen of the mobile or web device in order to capture the picture/photograph.

The user will stand facing the camera or web device and using the camera feature allow the camera feature to take a FRONT picture/photograph of their human body or object.

The user will view a silhouette of how to stand fitting the human body inside the frame shown on the screen of the mobile or web device. User will stand with arms and legs apart will appear in order to allow circumference measurement.

A picture/photograph of the human body or object can be taken by using the camera feature on the mobile or web device.

For measuring the circumference of the object the user will place the object within the frame of the picture/photograph shown on the screen of the mobile or web device.

The user is given audio and visual countdown to alert the user that the camera feature is preparing to take the picture/photograph. The user may also allow someone else to take the picture/photograph of their human body or object.

The user will then be prompted to follow the same procedure and take picture/photograph of a side view of the human body or object.

The user will view a picture/photograph of their human body or object on the screen of the mobile device or web device.

The user continues to follow the audio and visual instructions. The user will use the line indicators provided which can be dragged using a finger on the picture/photograph of the human body or object on the screen to show the top of the users head or top of object. The user will use the line indicator provided which can be dragged using a finger on the picture on the screen to show the bottom of the feet or bottom of object

The user will use the line indicator provided and drag to the area or parts of the human body or object to show where the circumference measurement is desired.

The user will then be prompted through audio and visual instructions to view a picture/photograph of the SIDE of their human body and repeat the procedure above for lining the top and bottom the picture of the human body or object.

The user will use the line indicator provided and drag to the area/parts of the human body or object to show where the circumference measurement is desired.

The circumference/width/length measurement will be displayed on the screen aside the picture/photograph of the body parts/area of the human body or object

The user will view the circumference measurement.

The user will have the ability to store the measurement in the menu section by tapping the save tab located on the picture/photograph on the screen of the mobile web device.

The user may return to the front picture/photograph of the human body or object and measure additional parts/areas of the human body or object by repeating the same format but selecting a different body part/area on the picture/photograph of the front and side of the human body or object.

### BRIEF DESCRIPTION OF THE DRAWINGS

Further aspects of the present disclosure together with additional features contributing and advantages will be apparent from the following description of embodiments of the disclosure, which are shown in the accompanying drawing figures wherein:

FIG. 1 Shows a mobile device screen for entering the height of the user or object.

FIG. 2 Shows a mobile device screen of a picture/photograph of the human body
a. Shows the top line indicator where the user will line the top of their head or object.
b. Shows the bottom line indicator where the user will line the bottom of their feet or object.
c. Shows the part or area on the picture/photograph of the human body
   where the measurement of the circumference is desired.
d. Shows tab for the selection of a front view of the picture/photograph of the human body
e. Shows the tab for the selection of a side view of the picture/photograph of the human body

FIG. 3 Shows a mobile device screen of a picture/photograph of the front view measurement of the waist circumference of the human body.

FIG. 4 Shows a mobile device screen of a picture/photograph of the side view measurement of the waist circumference of the human body.

FIG. 5 Shows a mobile device screen of the menu where the measurements of the selected body parts/areas are stored for the user to view.

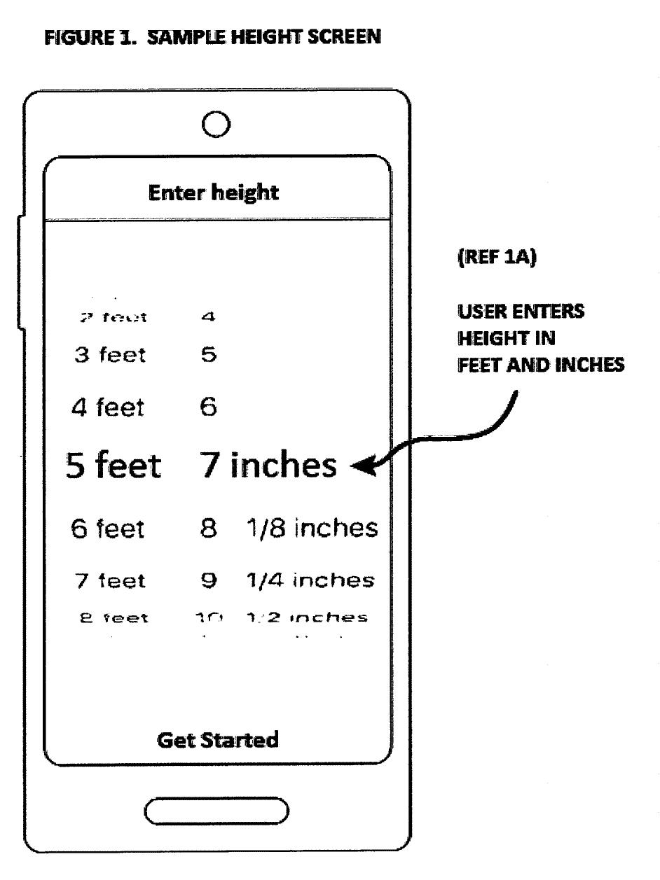

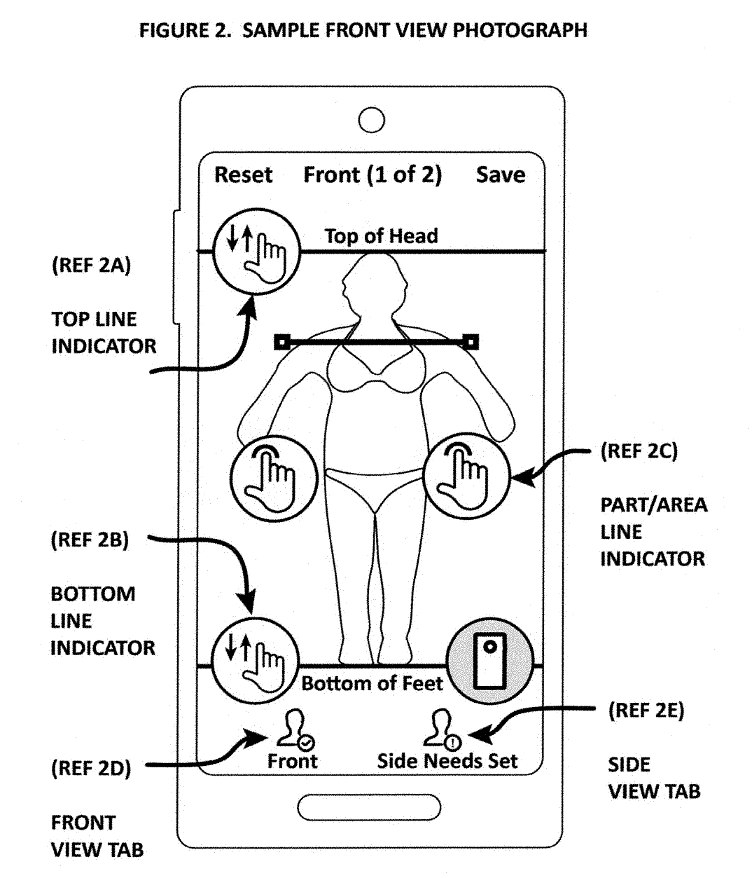

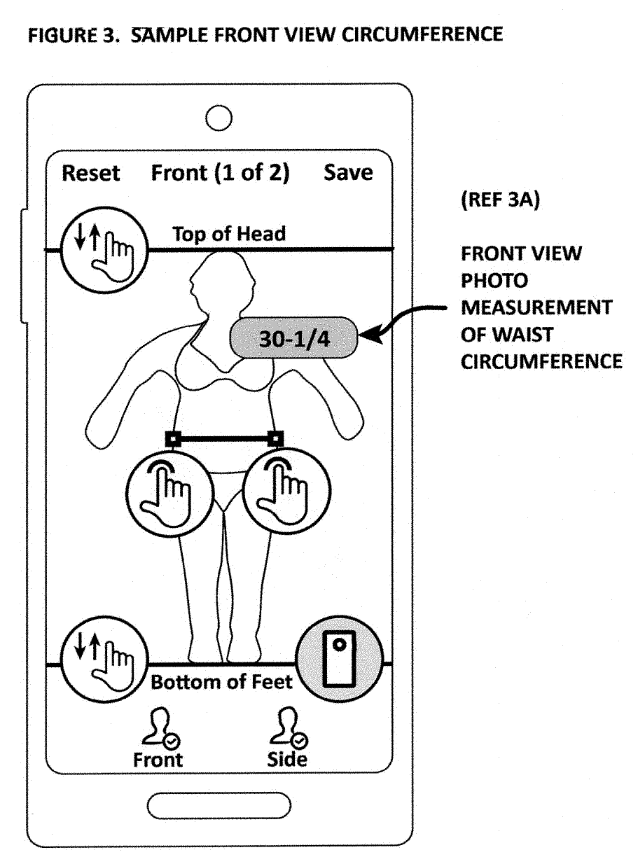

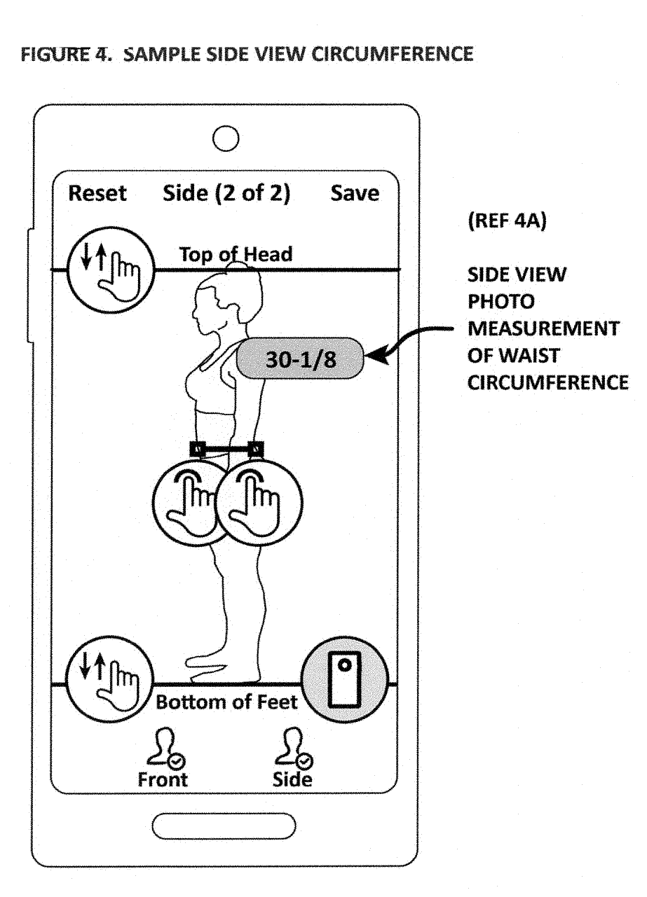

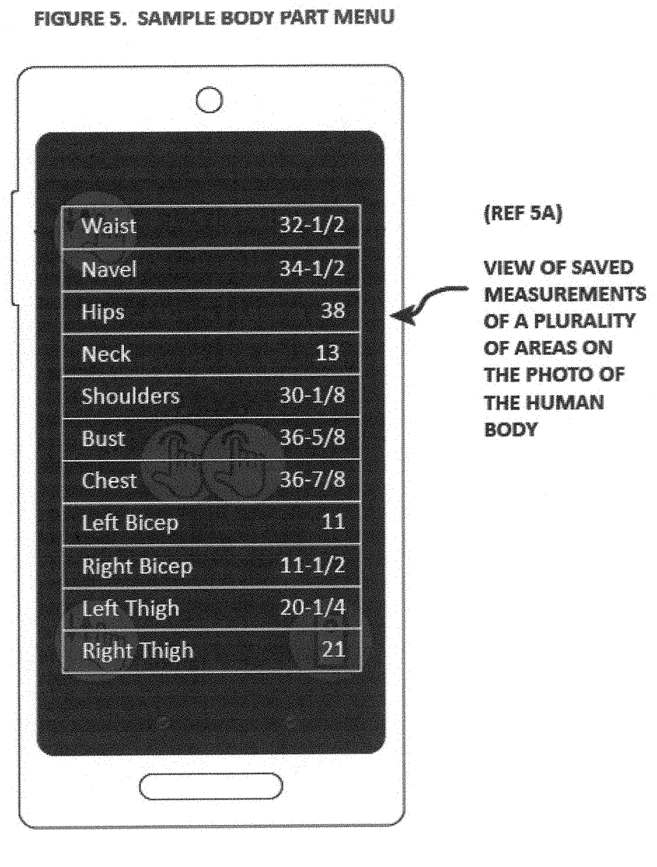

### DETAILED DESCRIPTION OF THE INVENTION

This invention method is based on measuring the width/length/circumference of parts/areas of a human body or object using a picture/photograph of a human body or object from a mobile camera or web camera feature.

The user downloads the app from their app store or onto their web device screen.

The user then enters their exact height in feet and inches.

The user would then press the continue tab to be taken to the next screen where they will follow audio and visual instructions to either take a self-picture or have someone else take their picture.

The entire body will need to fit into the frame located on the picture screen that the user will view.

The user is instructed on what to wear and how to stand to get the most accurate measurements. The user will be instructed to (if taking a self-picture, to make sure the phone is sitting completely vertical, at a length that allows them to see their entire body in the frame on the screen of the mobile device or web camera feature. The user is instructed to walk backwards until they see their entire body in the frame.

Once they see their entire body in the frame they are shown a visual of how to stand.

Arms should be away from the sides of the body and feet separated. A camera icon appears at the bottom of the screen where the user is instructed to tap and walk back to the original spot where they stood to fit themselves into the frame with arms out to their side away from the body and legs separated.

The user is given a 10 second countdown before the picture is automatically taken.

If the user is having the picture taken by someone else they follow the same instructions making sure that the phone is being held completely vertical.

Once the front picture is taken the user then follows the audio and visual instructions to take a side picture. The user simply turns to the side fitting themselves again in the visual frame on the picture screen of the mobile device or web screen. The user is again given a 10 second countdown and a side view picture is taken.

The user is shown a front picture of their current body on the screen of the mobile or web camera.

The user follows the audio and visual instructions is given a 10 second countdown and the mobile camera or web camera feature takes a side view automatically.

The user views the picture of the side view

The user has the option after both pictures are taken to keep the current pictures or retake.

The user selects to use the current photo.

The user follows the audio and visual instructions to line top line indicators shown on the screen by using their finger to drag indicator to the top of the head. The user follows the audio and visual instructions to use their finger to drag the bottom line indicators to the bottom of their feet.

The user follows the audio and visual instructions to tap the area/part of their body or object from the front view that they wish to measure.

The user is shown on the front view picture a measurement, not the final measurement however.

The user then follows the audio and visual instructions to go to side view picture screen where the user is shown the parts/area where they wish to measure circumference from where they indicated on the front view.

The user follows the audio and visual instructions to make sure again that the top of the head and the bottom of the feet are still lined up with the top and bottom line indicators. This will ensure that the area/part that the user wishes to measure will be at the same area on the picture.

The user will view the area/part of the human body or object they wish to measure and will automatically view the circumference measurement. This circumference appears automatically on the picture screen of the human body or object.

The user may return to the front view picture and tap other parts/areas of the human body or object that they wish to measure and follow the same procedures.

For example, the user may measure all areas of their body or object by returning to front screen and side screen and tapping the area/parts they wish to view circumference.

The user may store the measurements on the store measurement screen which allows them to use for comparison or for ordering clothing on line,

Having garments special made or to keep track of body composition change relating to diet or exercise programs.

The invention shows and stores body change data which can become a part of a global data base that shows/collects/and stores how body shapes change and the circumference of the individuals body shapes.

The invention can be used by physicians to analyze change in body composition due to swelling or health related issues especially in pre- and post surgeries.

The invention can be used by coaches and athletic trainers to determine how the specific programs work to change the composition of the body.

The invention can be used to help alert users to a high waist to height ratio which can lead to diseases such as Type 2 diabetes, heart disease, and hypertension.

The invention can be used by gynecologist to measure circumference of abdominal area in pregnant women to ensure proper growth proportion to growth of baby.

The invention can be used by schools and institutions to replace the current system of using BMI (which is widely considered an invalid method for determining the overall health of youth and adults.

The invention can be used by retailers, consumers and manufactures to ensure proper sizing and decrease online returns which cost consumers and manufacturers millions of dollars.

The invention can be used by manufacturers and retailers to determine what the average size and body shape is of most of their consumers. This will save millions of dollars in production cost.

This invention can be used by bridal and tailoring companies which will allow the convenience of the customer being able take their measurements in the privacy of their home and transmit the measurements to bridal or tailor to ensure proper fitting of custom made clothing.

This invention can be used to measure the circumference of any object to ensure a proper fit or placement within an area.

This invention can be used by fisherman and like to measure fish or any animal for mounting or taxidermy.

1. A method of measuring width/length/circumference of parts/areas of a human body or object comprising:
a. Using a picture/photograph of a human body or object from a mobile camera or camera feature
b. Selecting the height of the human body or object
c. Selecting the top of the human body or object
d. Selecting the bottom of the human body or object
e. Selecting the area/parts on the picture/photograph of the human body or object where circumference is desired.
f. Viewing the measurement of the circumference on the picture/photograph of the human body or object where the circumference is desired.
